(19) United States
(12) Patent Application Publication
(10) Pub. No.: US 2025/0033262 A1
(43) Pub. Date: Jan. 30, 2025

(54) SYSTEMS AND METHODS FOR REPROCESSING POLYMERIC MATERIAL DURING A MOLDING PROCESS

(71) Applicant: Richard Sofia, Troy, OH (US)

(72) Inventor: Richard Sofia, Troy, OH (US)

(21) Appl. No.: 18/361,489

(22) Filed: Jul. 28, 2023

(51) Int. Cl. B29C 45/47; B29C 45/00; B29C 45/03; B29C 45/60; B29C 45/74

(52) U.S. Cl. CPC B29C 45/47; B29C 45/0013; B29C 45/03; B29C 45/60; B29C 45/74; B29C 2045/0098; B29C 2045/1875; B29K 2105/16; B29K 2105/26

(57) ABSTRACT

Molding systems and methods for molding are disclosed. An example molding system may include a barrel having an input and an output. The barrel may have an inner diameter. A hopper for supplying a polymer material may be coupled to the input. The output may be configured to be coupled to a mold. A screw may be disposed in the barrel. The screw may have an outer diameter with a tight tolerance with the inner diameter of the barrel so that feeding the polymer material along the screw and through the barrel imparts shear forces onto the polymer material sufficient to alter the molecular structure of the polymer material and form a compounded material. A motor may be coupled to the screw. The motor may be configured to rotate the screw within the barrel. The screw may be axially fixed within the barrel so as to not reciprocate during a molding procedure. Alternatively, the screw may be configured to reciprocate within the barrel.

### TECHNICAL FIELD

The present disclosure pertains to molding systems and methods for molding. More particularly, the present disclosure pertains to molding systems for reprocessing polymeric material during a molding process.

### BACKGROUND

A wide variety of molding systems and processes have been developed for molding parts. Some of these systems and processes include injection molding systems, injection molding processes, and the like. Of the known molding systems and processes, each has certain advantages and disadvantages. There is an ongoing need to provide alternative molding systems as well as alternative molding processes.

### BRIEF SUMMARY

This disclosure provides design, material, manufacturing method, and use alternatives for molding systems. A molding system is disclosed. The molding system comprises: a barrel having an input and an output, the barrel having an inner diameter; a hopper for supplying a polymer material coupled to the input; wherein the output is configured to be coupled to a mold; a screw disposed in the barrel, the screw having an outer diameter with a tight tolerance with the inner diameter of the barrel so that feeding the polymer material along the screw and through the barrel imparts shear forces onto the polymer material sufficient to alter the molecular structure of the polymer material and form a compounded material; a motor coupled to the screw, the motor being configured to rotate the screw within the barrel; and wherein the screw is configured to reciprocate or not reciprocate during a molding procedure and add shear force between an end of the screw and an inner wall of the barrel.

Alternatively or additionally to any of the embodiments above, the screw includes a screw root and a flight disposed about the screw root.

Alternatively or additionally to any of the embodiments above, the flight defines the outer diameter of the screw.

Alternatively or additionally to any of the embodiments above, further comprising a heating system coupled to the barrel for heating the barrel.

Alternatively or additionally to any of the embodiments above, wherein the shear force results in internal heating between the screw and barrel.

Alternatively or additionally to any of the embodiments above, rotating the screw urges the polymer material against an inner wall of the barrel to create the shear forces.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the polymer material further comprises a mineral, a biological resin, an impact modifier, rubber, glass, or combinations thereof.

Alternatively or additionally to any of the embodiments above, the polymer material further comprises an antioxidant additive, a melt enhancer, or combinations thereof.

Alternatively or additionally to any of the embodiments above, the output is an enlarged output configured to enhance the flow of material from the barrel to the mold.

Alternatively or additionally to any of the embodiments above, the enlarged output has a diameter of 0.1875-2.0 inches or more.

Alternatively or additionally to any of the embodiments above, the enlarged output has a diameter of 0.25-2.0 inches or more.

Alternatively or additionally to any of the embodiments above, the input is an enlarged input configured to enhance the flow of material from the hopper to the barrel.

A molding system is disclosed. The molding system comprises: a barrel having an input and an output, the barrel having an inner diameter; a hopper for supplying a polymer material coupled to the input; wherein the output is configured to be coupled to a mold; the system including a single screw; the single screw disposed in the barrel, the single screw having an outer diameter with a tight tolerance with the inner diameter of the barrel so that feeding the polymer material along the single screw and through the barrel imparts shear forces onto the polymer material sufficient to alter the molecular structure of the polymer material and form a compounded material; a motor coupled to the single screw, the motor being configured to rotate the screw within the barrel.

Alternatively or additionally to any of the embodiments above, the screw includes a screw root and a flight disposed about the screw root.

Alternatively or additionally to any of the embodiments above, the flight defines the outer diameter of the screw.

Alternatively or additionally to any of the embodiments above, further comprising a heating system coupled to the barrel for heating the barrel.

Alternatively or additionally to any of the embodiments above, rotating the screw urges the polymer material against an inner wall of the barrel to create the shear forces.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the polymer material further comprises a mineral, a biological resin, an impact modifier, rubber, glass, or combinations thereof.

Alternatively or additionally to any of the embodiments above, the polymer material further comprises an antioxidant additive, a melt enhancer, or combinations thereof.

Alternatively or additionally to any of the embodiments above, the output is an enlarged output configured to enhance the flow of material from the barrel to the mold.

Alternatively or additionally to any of the embodiments above, the enlarged output has a diameter of 0.1875-2.0 inches or more.

Alternatively or additionally to any of the embodiments above, the enlarged output has a diameter of 0.25-2.0 inches or more.

Alternatively or additionally to any of the embodiments above, the input is an enlarged input configured to enhance the flow of material from the hopper to the barrel.

A molding system is disclosed. The molding system comprises: a barrel having an input and an output, the barrel having an inner diameter; a hopper for supplying a polymer material coupled to the input; wherein the output is configured to be coupled to a mold; a screw disposed in the barrel, the screw having an outer diameter with a tight tolerance with the inner diameter of the barrel so that feeding the polymer material along the screw and through the barrel imparts shear forces onto the polymer material sufficient to alter the molecular structure of the polymer material and form a compounded material; a motor coupled to the screw, the motor being configured to rotate the screw within the barrel; and wherein the screw is axially fixed within the barrel so as to not reciprocate during a molding procedure.

Alternatively or additionally to any of the embodiments above, the screw includes a screw root and a flight disposed about the screw root.

Alternatively or additionally to any of the embodiments above, the flight defines the outer diameter of the screw.

Alternatively or additionally to any of the embodiments above, further comprising a heating system coupled to the barrel for heating the barrel.

Alternatively or additionally to any of the embodiments above, rotating the screw urges the polymer material against an inner wall of the barrel to create the shear forces.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the polymer material further comprises a mineral, a biological resin, an impact modifier, rubber, glass, or combinations thereof.

Alternatively or additionally to any of the embodiments above, the polymer material further comprises an antioxidant additive, a melt enhancer, or combinations thereof.

Alternatively or additionally to any of the embodiments above, the output is an enlarged output configured to enhance the flow of material from the barrel to the mold.

Alternatively or additionally to any of the embodiments above, the enlarged output has a diameter of 0.1875-2.0 inches or more.

Alternatively or additionally to any of the embodiments above, the enlarged output has a diameter of 0.25-2.0 inches or more.

Alternatively or additionally to any of the embodiments above, the input is an enlarged input configured to enhance the flow of material from the hopper to the barrel.

A molding system is disclosed. The molding system comprises: a barrel having an input and an output, the barrel having an inner diameter; a hopper for supplying a polymer material coupled to the input; wherein the output is configured to be coupled to a mold; a screw disposed in the barrel, the screw having an outer diameter with a tight tolerance with the inner diameter of the barrel so that feeding the polymer material along the screw and through the barrel imparts shear forces onto the polymer material sufficient to alter the molecular structure of the polymer material and form a compounded material; a motor coupled to the screw, the motor being configured to rotate the screw within the barrel; and wherein the screw is configured to reciprocate during a molding procedure and add shear force between an end of the screw and an inner wall of the barrel.

Alternatively or additionally to any of the embodiments above, the screw includes a screw root and a flight disposed about the screw root.

Alternatively or additionally to any of the embodiments above, the flight defines the outer diameter of the screw.

Alternatively or additionally to any of the embodiments above, further comprising a heating system coupled to the barrel for heating the barrel.

Alternatively or additionally to any of the embodiments above, wherein the shear force results in internal heating between the screw and barrel.

Alternatively or additionally to any of the embodiments above, rotating the screw urges the polymer material against an inner wall of the barrel to create the shear forces.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the polymer material further comprises a mineral, a biological resin, an impact modifier, rubber, glass, or combinations thereof.

Alternatively or additionally to any of the embodiments above, the polymer material further comprises an antioxidant additive, a melt enhancer, or combinations thereof.

Alternatively or additionally to any of the embodiments above, the output is an enlarged output configured to enhance the flow of material from the barrel to the mold.

Alternatively or additionally to any of the embodiments above, the enlarged output has a diameter of 0.1875-2.0 inches or more.

Alternatively or additionally to any of the embodiments above, the enlarged output has a diameter of 0.25-2.0 inches or more.

Alternatively or additionally to any of the embodiments above, the input is an enlarged input configured to enhance the flow of material from the hopper to the barrel.

A molding system is disclosed. The molding system comprises: a barrel having an input and an output, the barrel having an inner diameter; a hopper for supplying a polymer material coupled to the input; wherein the output is configured to be coupled to a mold; a screw disposed in the barrel, the screw having an outer diameter with a tight tolerance with the inner diameter of the barrel so that feeding the polymer material along the screw and through the barrel imparts shear forces onto the polymer material sufficient to alter the molecular structure of the polymer material and form a compounded material; a motor coupled to the screw, the motor being configured to rotate the screw within the barrel; and wherein the screw is configured to add shear force between an end of the screw and an inner wall of the barrel.

Alternatively or additionally to any of the embodiments above, the screw includes a screw root and a flight disposed about the screw root.

Alternatively or additionally to any of the embodiments above, the flight defines the outer diameter of the screw.

Alternatively or additionally to any of the embodiments above, further comprising a heating system coupled to the barrel for heating the barrel.

Alternatively or additionally to any of the embodiments above, wherein the shear force results in internal heating between the screw and barrel.

Alternatively or additionally to any of the embodiments above, rotating the screw urges the polymer material against an inner wall of the barrel to create the shear forces.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the polymer material further comprises a mineral, a biological resin, an impact modifier, rubber, glass, or combinations thereof.

Alternatively or additionally to any of the embodiments above, the polymer material further comprises an antioxidant additive, a melt enhancer, or combinations thereof.

Alternatively or additionally to any of the embodiments above, the output is an enlarged output configured to enhance the flow of material from the barrel to the mold.

Alternatively or additionally to any of the embodiments above, the enlarged output has a diameter of 0.1875-2.0 inches or more.

Alternatively or additionally to any of the embodiments above, the enlarged output has a diameter of 0.25-2.0 inches or more.

Alternatively or additionally to any of the embodiments above, the input is an enlarged input configured to enhance the flow of material from the hopper to the barrel.

Alternatively or additionally to any of the embodiments above, the screw is axially fixed within the barrel so as to not reciprocate during a molding procedure.

Alternatively or additionally to any of the embodiments above, the screw is configured to reciprocate within the barrel.

A method for reprocessing resin during a molding process is disclosed. The method comprises: disposing a polymer material into a hopper of a molding system, the hopper being coupled to a barrel having a screw disposed therein; feeding the polymer material through an input of the barrel and into the barrel; heating the barrel; rotating the screw while keeping the screw axially fixed relative to the barrel, wherein rotating the screw presses the polymer material against an inner wall of the barrel to create shear forces sufficient to alter the molecular structure of the polymer material and form a compounded material; and advancing the compounded material through an output of the barrel and into a mold.

Alternatively or additionally to any of the embodiments above, the screw has an outer diameter with a tight tolerance with an inner diameter of the barrel.

Alternatively or additionally to any of the embodiments above, the polymer

material includes a plurality of different polymer resins.

Alternatively or additionally to any of the embodiments above, the polymer material includes a recycled polymer material.

Alternatively or additionally to any of the embodiments above, the output has a diameter of 0.1875-2.0 inches or more.

A method for reprocessing resin during a molding process is disclosed. The method comprises: disposing a polymer material into a hopper of a molding system, the hopper being coupled to a barrel having a screw disposed therein; feeding the polymer material through an input of the barrel and into the barrel; heating the barrel; rotating the screw, wherein rotating the screw presses the polymer material against an inner wall of the barrel to create shear forces sufficient to alter the molecular structure of the polymer material and form a compounded material; and advancing the compounded material through an output of the barrel and into a mold.

Alternatively or additionally to any of the embodiments above, the screw has an outer diameter with a tight tolerance with an inner diameter of the barrel.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the output has a diameter of 0.1875-2.0 inches or more.

Alternatively or additionally to any of the embodiments above, the screw is axially fixed within the barrel so as to not reciprocate.

Alternatively or additionally to any of the embodiments above, the screw is configured to reciprocate within the barrel.

A method for reprocessing resin during a molding process is disclosed. The method comprises: disposing a polymer material into a hopper of a molding system that includes a single screw, the hopper being coupled to a barrel having the single screw disposed therein; feeding the polymer material through an input of the barrel and into the barrel; heating the barrel; rotating the single screw, wherein rotating the single screw presses the polymer material against an inner wall of the barrel to create shear forces sufficient to alter the molecular structure of the polymer material and form a compounded material; and advancing the compounded material through an output of the barrel and into a mold.

Alternatively or additionally to any of the embodiments above, the screw has an outer diameter with a tight tolerance with an inner diameter of the barrel.

Alternatively or additionally to any of the embodiments above, the polymer material includes a plurality of different polymer resins.

Alternatively or additionally to any of the embodiments above, the polymer material includes a recycled polymer material.

Alternatively or additionally to any of the embodiments above, the output has a diameter of 0.1875-2.0 inches or more.

Alternatively or additionally to any of the embodiments above, the screw is axially fixed within the barrel so as to not reciprocate.

Alternatively or additionally to any of the embodiments above, the screw is configured to reciprocate within the barrel.

A method for reprocessing resin during a molding process is disclosed. The method comprises: disposing a polymer material into a hopper of a molding system, the hopper being coupled to a barrel having a reciprocating screw disposed therein; feeding the polymer material through an input of the barrel and into the barrel; heating the barrel; rotating the screw, wherein rotating the screw presses the polymer material against an inner wall of the barrel to create shear forces sufficient to alter the molecular structure of the polymer material and form a compounded material; and advancing the compounded material through an output of the barrel and into a mold.

Alternatively or additionally to any of the embodiments above, the screw has an outer diameter with a tight tolerance with an inner diameter of the barrel.

Alternatively or additionally to any of the embodiments above, the polymer

material includes a plurality of different polymer resins.

Alternatively or additionally to any of the embodiments above, the polymer material includes a recycled polymer material.

Alternatively or additionally to any of the embodiments above, the output has a diameter of 0.1875-2.0 inches or more.

A modified injection molding system with direct line compounding is disclosed. The system comprises: a barrel for feeding a polymer material to a mold; a hopper for supplying the polymer material to the barrel; a non-reciprocating screw disposed in the barrel, the non-reciprocating screw having an outer diameter that is within 0.125 inches or less of an inner diameter of the barrel; wherein the non-reciprocating screw is configured to rotate within the barrel; and wherein feeding the polymer material along the non-reciprocating screw and through the barrel imparts shear forces onto the polymer material sufficient to alter the molecular structure of the polymer material and form a compounded material.

Alternatively or additionally to any of the embodiments above, rotating the screw urges the polymer material against an inner wall of the barrel to create the shear forces.

Alternatively or additionally to any of the embodiments above, the barrel includes an output for transferring the polymer material from the barrel to the mold, and wherein the output has a diameter of 0.1875-2.0 inches or more.

A modified injection molding system with direct line compounding is disclosed. The system comprises: a barrel for feeding a polymer material to a mold; a hopper for supplying the polymer material to the barrel; a screw disposed in the barrel, the screw having an outer diameter that is within 0.125 inches or less of an inner diameter of the barrel; wherein the screw is configured to rotate within the barrel; and wherein feeding the polymer material along the screw and through the barrel imparts shear forces onto the polymer material sufficient to alter the molecular structure of the polymer material and form a compounded material.

Alternatively or additionally to any of the embodiments above, rotating the screw urges the polymer material against an inner wall of the barrel to create the shear forces.

Alternatively or additionally to any of the embodiments above, the barrel includes an output for transferring the polymer material from the barrel to the mold, and wherein the output has a diameter of 0.1875-2.0 inches or more.

Alternatively or additionally to any of the embodiments above, the screw is axially fixed within the barrel so as to not reciprocate.

Alternatively or additionally to any of the embodiments above, the screw is configured to reciprocate within the barrel.

A modified injection molding system with direct line compounding is disclosed. The system comprises: a barrel for feeding a polymer material to a mold; a hopper for supplying the polymer material to the barrel; a reciprocating screw disposed in the barrel, the reciprocating screw having an outer diameter that is within 0.125 inches or less of an inner diameter of the barrel; wherein the reciprocating screw is configured to rotate within the barrel; and wherein feeding the polymer material along the reciprocating screw and through the barrel imparts shear forces onto the polymer material sufficient to alter the molecular structure of the polymer material and form a compounded material.

Alternatively or additionally to any of the embodiments above, rotating the screw urges the polymer material against an inner wall of the barrel to create the shear forces.

Alternatively or additionally to any of the embodiments above, the barrel includes an output for transferring the polymer material from the barrel to the mold, and wherein the output has a diameter of 0.1875-2.0 inches or more.

Alternatively or additionally to any of the embodiments above, the single screw is axially fixed within the barrel so as to not reciprocate.

Alternatively or additionally to any of the embodiments above, the single screw is configured to reciprocate within the barrel.

A modified injection molding system with direct line compounding is disclosed. The system comprises: a barrel for feeding a polymer material to a mold; a hopper for supplying the polymer material to the barrel; a single screw disposed in the barrel, the single screw having an outer diameter that is within 0.125 inches or less of an inner diameter of the barrel; wherein the single screw is configured to rotate within the barrel; and wherein feeding the polymer material along the single screw and through the barrel imparts shear forces onto the polymer material sufficient to alter the molecular structure of the polymer material and form a compounded material.

Alternatively or additionally to any of the embodiments above, rotating the screw urges the polymer material against an inner wall of the barrel to create the shear forces.

Alternatively or additionally to any of the embodiments above, the barrel includes an output for transferring the polymer material from the barrel to the mold, and wherein the output has a diameter of 0.1875-2.0 inches or more.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a schematic side view of an example molding system.

FIG. 2 is a cross-sectional view taken through line 2-2 in FIG. 1.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

Injection molding processes are commonplace among manufacturers that work with a variety of polymer materials. At a high level, injection molding systems utilize a hopper that feeds into a barrel. A reciprocating screw is disposed within the barrel. As material is fed into the barrel, the barrel heats the material and the screw turns to push the material forward. As the material flows forward toward a mold, the material can build up, causing the screw to shift backward (e.g., away from the mold). Once enough material is built up in front of the screw, the screw can be thrust forward, thereby injecting the material into a mold.

Other polymer technologies include compounding (e.g., which may include or otherwise be interchangeable with extruding). Compounding may include feeding one or more materials into a hopper and into a barrel (e.g., an extruder). A screw having a tight tolerance with the barrel may move the material forward while generating shear forces on the material. The shear forces can change the molecular structure of the material and/or otherwise combine the input materials to form a new material. The new material can then be advanced through a die, cooled, and then chopped into pellets.

In practice, a polymer processing facility may use a compounding system to generate pellets of polymer/resin material. The newly formed pellets can then be used in an injection molding system to form injected molded products. This workflow uses two different lines of machinery and processes. It may be desirable to reduce the amount of machinery at a given processing facility and/or reduce/simplify the processing steps. Disclosed herein are new molding systems and molding processes. The molding systems and molding processes may help to reduce the amount of machinery needed to form polymer molded products and/or reduce/simplify the processes needed to produce polymer molded products. Some additional details regarding the molding systems and molding processes are disclosed herein.

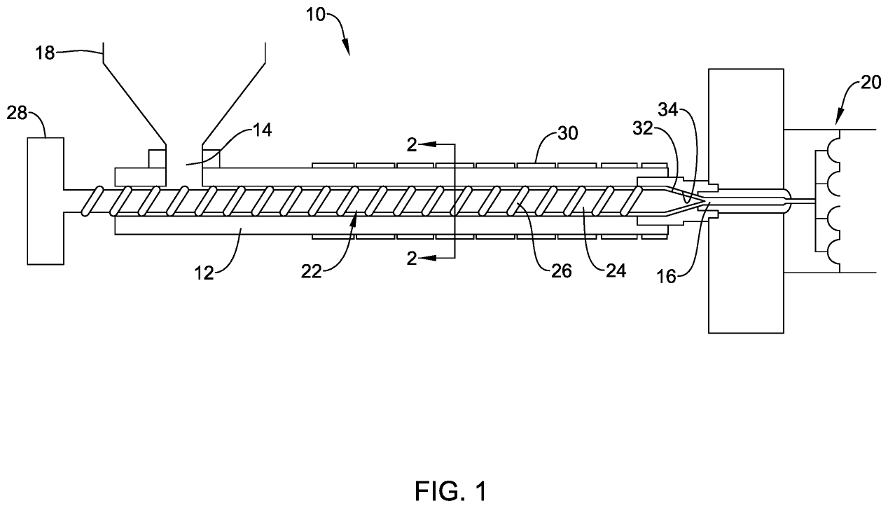

FIG. 1 is a schematic side view of an example molding system 10. The molding system 10 may be considered to be a modified injection molding system and/or a combination of a compounding system (e.g., extruder) and injection molding system. The molding system 10 may include a barrel 12 having an input 14 and an output 16. A hopper 18, for example for supplying polymer material, may be coupled to the input 14. The output 16 of the barrel 12 may be coupled to a mold 20.

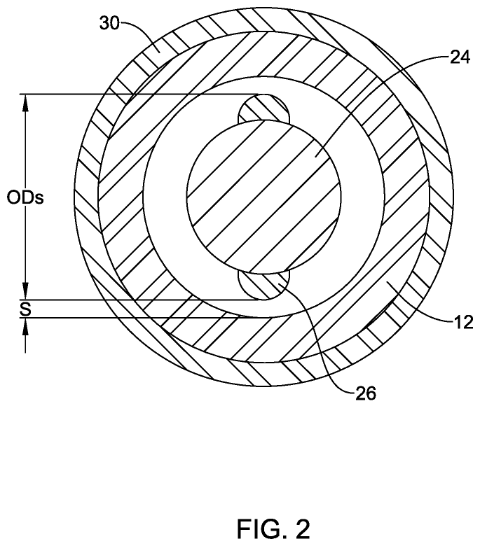

A screw 22 may be disposed in the barrel 12. Unlike typical injection molding apparatuses, the screw 22 may have an outer diameter that closely approximates the inner diameter of the barrel 12. In other words, the screw 22 may have a relatively tight tolerance with the barrel so that feeding the polymer material along the screw and through the barrel imparts shear forces onto the polymer material sufficient to alter the molecular structure of the polymer material and/or combine the materials fed into the barrel 12 so as to form a new and/or compounded material. For example, in some instances, the screw 22 may include a screw root 24 and a flight 26 disposed about the screw root 24. The flight 26 may define the outer diameter ODs of the screw 22 as shown schematically in FIG. 2. The outer diameter ODs of the screw 22 may have a relatively tight tolerance with the inner diameter of the barrel 12 so that a relatively small distance or space S exists between the outer diameter ODs of the screw 22 and the inner diameter or wall of the barrel 12. In this example, the tight tolerance between the screw 22 and the inner diameter or wall of the barrel 12 may be along the length of the screw 22. In some of these and in other instances, there may be a tight tolerance between a tip or end region 32 of the screw 22 and the inner wall of the barrel 12 (e.g., at a region 34 adjacent to the end region 32 of the screw 22).

In some instances, the space S may be 0.25 inches or less, or about 0.125 inches or less, or about 0.0625 inches or less, or about 0.03125 inches or less, or about 0.015625 inches or less. It can be appreciated that the dimension of the space S may vary based on the scale of the system 10. Because of scaling, it may be suitable to describe or understand the relatively tight tolerance in terms of the relative area inside the barrel taken up by the screw. For example, the inner wall of the barrel 12 may define an area. The screw 22 may take up a relatively large portion of the area. For example, the screw 22 may take up about 80% or more of the area, or about 85% or more of the area, or about 90% or more of the area, or about 95% or more of the area. Another way to describe or understand the relatively tight tolerance between the screw 22 and the barrel 12 is to compare the outer diameter of the screw 22 with the inner dimeter of the barrel 12. For example, the outer diameter of the screw 22 may have a size/magnitude that is about 80% or more of the size/magnitude of the inner diameter of the barrel 12, or about 85% or more of the size/magnitude of the inner diameter of the barrel 12, or about 90% or more of the size/magnitude of the inner diameter of the barrel 12, or about 95% or more of the size/magnitude of the inner diameter of the barrel 12, or about 96% or more of the size/magnitude of the inner diameter of the barrel 12, or about 97% or more of the size/magnitude of the inner diameter of the barrel 12, or about 98% or more of the size/magnitude of the inner diameter of the barrel 12, or about 99% or more of the size/magnitude of the inner diameter of the barrel 12.

The end region 32 of the screw 22 may also have a tight tolerance with the barrel 12 (e.g., at a region 34 adjacent to the end region 32 of the screw 22). For example, the end region of screw 22 may take up about 80% or more of the cross-sectional area of the barrel 12, or about 85% or more of the cross-sectional area, or about 90% or more of the cross-sectional area, or about 95% or more of the cross-sectional area. Another way to describe or understand the relatively tight tolerance between the end region 32 of the screw 22 and the inner wall of the barrel 12 is to compare the outer diameter of the end region 32 of the screw 22 with the inner dimeter of the barrel 12. For example, the outer diameter of the end region 32 of the screw 22 may have a size/magnitude that is about 80% or more of the size/magnitude of the inner diameter of the barrel 12, or about 85% or more of the size/magnitude of the inner diameter of the barrel 12, or about 90% or more of the size/magnitude of the inner diameter of the barrel 12, or about 95% or more of the size/magnitude of the inner diameter of the barrel 12, or about 96% or more of the size/magnitude of the inner diameter of the barrel 12, or about 97% or more of the size/magnitude of the inner diameter of the barrel 12, or about 98% or more of the size/magnitude of the inner diameter of the barrel 12, or about 99% or more of the size/magnitude of the inner diameter of the barrel 12. For example, the tolerance between the end region 32 of the screw 22 and the inner wall of the barrel 12 (e.g., adjacent region 34) may be on the order of about 0.002-0.01 inches or so.

The screw 22 may be a non-reciprocating screw 22. In other words, the screw may be axially fixed within the barrel so as to not reciprocate during a molding procedure. Thus, unlike a typical injection molding system where material can accumulate near the output and can the screw to move backwards before injecting the material into the mold, the screw 22 remains stationary. Because the screw 22 does not reciprocate, as the screw 22 rotates, the screw 22 will urge/push the polymer material within the barrel 12 against the wall (e.g., the inner wall) of the barrel 12. This may create shear forces within the barrel 12 that can act upon the material within the barrel 12 and alter the molecular structure of the polymer material and/or combine the materials fed into the barrel 12 so as to form a new and/or compounded material. This compounding does not occur in tradition injection molding systems. Therefore, the materials fed into a tradition injection molding system match the materials exiting the system. In contrast, the materials exiting the system 10 are different from those fed into the system 10.

In other instances, the screw 22 may be a reciprocating screw 22 that is configured to reciprocate within the barrel 12. If the screw 22 reciprocates, the screw 22 may urge/push the polymer material within the barrel 12 against the wall (e.g., the inner wall) of the barrel 12 and also into/along the front/end of the screw until material fills the void (e.g., between the end region 32 of the screw 22 and the inner wall of the barrel 12). This may create shear forces within the barrel 12 that can act upon the material within the barrel 12 and alter the molecular structure of the polymer material and/or combine the materials fed into the barrel 12 so as to form a new and/or compounded material.

It can be appreciated that a traditional injection molding system may include a single screw, but the screw is not arranged or configured as described herein. For example, a screw in a traditional injection molding system does not have a tight tolerance with the barrel and is not able to compound and/or form new/compounded materials. In addition, a traditional compounding system (e.g., and extruder) may include a single screw, but the screw is not arranged in configured as described herein. For example, a screw in a traditional compounding system is used to produced resin/pellets. A traditional compounding system cannot be used to mold new articles. Moreover, a two-part system where a traditional compounding system is arranged in-line with an injection molding system uses at least two screws. Such a two-part system differs from the disclosed system 10 in that a two-part system requires more hardware, more space, and multiple screws. In stark contrast, the system 10 disclosed herein provides the features and benefits of both an injection molding system and a compounding system while only using a single screw 22.

In some instances, the output 16 may be understood to be an enlarged output configured to enhance the flow of material from the barrel 12 to the mold 20. For example, the enlarged output may have a diameter of about 0.1875-2.0 inches or more, or about 0.25-2.0 inches or more. The larger output sizes would facilitate the flow of materials from the barrel 12 to the mold 20 at lower pressure. For example, a tradition injection molding system may use a high force/pressure to “inject” or “shoot” the material into a mold. In the instant system 10, the enlarged output 16 may facilitate the transfer of material (e.g., the new and/or compounded material) to the mold 20 without needing to “inject” or “shoot” the material into the mold 20. In some of these and in other instances, the length of the screw 22 can also be increased relative to the length of a screw in a traditional injection molding system. This may allow for a larger volume of material to be collected along the screw 22 (e.g., within the barrel 12) so that a large volume of material (e.g., a larger “charge”) can be fed into the mold 20. It can be appreciated that additional scaling can be utilized (e.g., enlarging the diameter of the barrel 12) in order to increase the volume of material to be fed into the mold 20.

In some instances, a motor 28 may be coupled to the screw 22. It can be appreciated that due to the tight tolerance between the screw 22 and the barrel 12, a greater amount of resistance, friction, and/or pressure that may be present within the system 10. Thus, the motor 28 may have an increased level of power and/or torque when compared to motors typically used with injection molding systems. For example, the motor 28 may have about 20-300% or more power than a motor used with a traditional injection molding system, or about 40-300% or more power than a motor used with a traditional injection molding system, or about 50-300% or more power than a motor used with a traditional injection molding system. It may also be useful to consider the horsepower of the motor 28 relative to a motor used with a traditional injection molding system. The motor 28 may have a higher horsepower than that of a motor used with a traditional injection molding system. For example, the horsepower of the motor 28 may be about 20% or more higher, or about 40% or more higher, or about 60% or more higher, or about 80% or more higher, or about 100% or more higher.

In some instances, a heating system 30 may be coupled to the barrel 12 (e.g., for heating the barrel 12 and/or melting/softening polymer material within the barrel 12). The heating system 30 may be configured to suitably heat the barrel 12 so that the materials disposed therein are softened, partially melted, and/or melted. In general, the heating system 30 may utilize a heating element disposed along the barrel 12. This is not intended to be limiting. A variety of different heating systems 30 are contemplated.

In some instances, the polymer material being fed into the barrel 12 (e.g., via the hopper 18) may include a singular type of polymer material. In other instances, the polymer material may include a plurality of different polymer materials/resins. When multiple polymer materials are utilized, similar or compatible materials may be selected/utilized. When the polymer materials are fed into the barrel 12 then can blend and form a combined, new material. In some instances, the polymer material(s) may include one or more recycled polymer material. In some instances, the polymer material may further comprise one or more minerals, biological resins, impact modifiers, rubber, glass, antioxidants, melt enhancers, combinations thereof, and/or the like. In some instances, the polymer material can be ground (e.g., to a size of about 0.5 inches or less, or about 0.25 inches or less) prior to being disposed into the hopper 18. This may help to facilitate melting and/or softening of the polymer material.

Some example polymer materials that may be utilized with the system 10 may include polyethylene terephthalate (PET), polyethylene, high-density polyethylene (HDPE), polyvinylchloride (PVC), low-density polyethylene (LDPE), polypropylene (PP), polyurethane, polyamide, polystyrene (PS), polycarbonate, acrylonitrile butadiene styrene (ABS), and/or the like. These are just examples. Other polymers are contemplated.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

1. A molding system that combines polymer compounding and injection molding, the molding system comprising:
a barrel having an input and an output, the barrel having an inner diameter and defining an inner cross-sectional area;
a hopper for supplying a polymer material coupled to the input;
wherein the output is configured to be coupled to a mold;
a screw disposed in the barrel, the screw having an outer diameter with a tight tolerance with the inner diameter of the barrel such that the screw fills 90% or more of the inner cross-sectional area of the barrel so that feeding the polymer material along the screw and through the barrel imparts shear forces onto the polymer material sufficient to alter the molecular structure of the polymer material and form a compounded material;
wherein the output is an enlarged output configured to enhance the flow of material from the barrel to the mold;
wherein the enlarged output has a diameter of 0.1875-2.0 inches or more; and
a motor coupled to the screw, the motor being configured to rotate the screw within the barrel.

2. The molding system of claim 1, wherein the screw includes a screw root and a flight disposed about the screw root.

3. The molding system of claim 2, wherein the flight defines the outer diameter of the screw.

4. The molding system of claim 1, further comprising a heating system coupled to the barrel for heating the barrel.

5. The molding system of claim 1, wherein rotating the screw urges the polymer material against an inner wall of the barrel to create the shear forces.

6. The molding system of claim 1, wherein the polymer material includes a plurality of different polymer resins.

7. The molding system of claim 1, wherein the polymer material includes a recycled polymer material.

8. The molding system of claim 1, wherein the polymer material further comprises a mineral, a biological resin, an impact modifier, rubber, glass, or combinations thereof.

9. The molding system of claim 1, wherein the polymer material further comprises an antioxidant additive, a melt enhancer, or combinations thereof. 10-11. (canceled)

12. The molding system of claim 1, wherein the enlarged output has a diameter of 0.25-2.0 inches or more.

13. A method for reprocessing resin during a molding process, the method comprising:
disposing a polymer material into a hopper of a molding system, the hopper being coupled to a barrel having a screw disposed therein;
feeding the polymer material through an input of the barrel and into the barrel;
heating the barrel;
rotating the screw, wherein rotating the screw presses the polymer material against an inner wall of the barrel to create shear forces sufficient to alter the molecular structure of the polymer material and form a compounded material; and
advancing the compounded material through an output of the barrel and into a mold.

14. The method of claim 13, wherein the screw has an outer diameter with a tight tolerance with an inner diameter of the barrel.

15. The method of claim 13, wherein the polymer material includes a plurality of different polymer resins.

16. The method of claim 13, wherein the polymer material includes a recycled polymer material.

17. The method of claim 13, wherein the output has a diameter of 0.1875-2.0 inches or more.

18. A modified injection molding system with direct line compounding, the comprising:
a barrel for feeding a polymer material to a mold, the barrel defining an area;
a hopper for supplying the polymer material to the barrel;
a screw disposed in the barrel, the non-reciprocating screw having an outer diameter that is within 0.125 inches or less of an inner diameter of the barrel such that the barrel fills 90% or more of the area of the barrel;
wherein the screw is configured to rotate within the barrel;
wherein the barrel defines an enlarged output configured to enhance the flow of material from the barrel to a mold, the enlarged output having a diameter of 0.1875-2.0 inches or more and that is larger than the outer diameter of the screw; and
wherein feeding the polymer material along the screw and through the barrel imparts shear forces onto the polymer material sufficient to alter the molecular structure of the polymer material and form a compounded material.

19. The system of claim 18, wherein rotating the screw urges the polymer material against an inner wall of the barrel to create the shear forces.

20. The system of claim 18, wherein the barrel includes an output for transferring the polymer material from the barrel to the mold, and wherein the output has a diameter of 0.1875-2.0 inches or more.

21. The molding system of claim 1, wherein the screw is a reciprocating screw.

22. The molding system of claim 1, wherein the screw is a non-reciprocating screw.
